(19) United States
(12) Patent Application Publication
(10) Pub. No.: US 2005/0223362 A1
(43) Pub. Date: Oct. 6, 2005

(54) Methods and systems for performing unit testing across multiple virtual machines

(75) Inventors: David Michael Whitlock, Portland, OR (US); Lise Storc, Portland, OR (US)

Correspondence Address: KLARQUIST SPARKMAN, LLP, 121 SW SALMON STREET, SUITE 1600, PORTLAND, OR, 97204, US

(73) Assignee: GemStone Systems, Inc.

(21) Appl. No.: 10/816,605

(22) Filed: Apr. 2, 2004

(51) Int. Cl. G06F 9/44

(52) U.S. Cl. 717/126

(57) ABSTRACT

A virtual machine manager executes a test program for performing unit test of target program on a plurality of virtual machines. The virtual machine manager creates a network of a specified plurality of virtual machines according to a configuration specification for conducting unit tests. Unit testing of the target program being executed on the specified plurality of virtual machines is then made possible by method of code invocation described herein whereby units of code of a target program may be specified along with one or more of virtual machines on which they are to be executed. In response to a failed execution, an exception object is thrown by the virtual machine on which the exception occurred and caught by the virtual machine manager for identifying the exact virtual machine in the network on which the exception occurred.

### TECHNICAL FIELD

The technical field relates to methods and systems for testing computer programs. More particularly, the field relates to methods and systems for performing unit tests on computer code to be executed across multiple virtual machines.

### BACKGROUND

Reliability of software plays a central role in its success in the market. No user will tolerate an unreliable piece of software. Therefore, it is not surprising that software developers subject software code to numerous levels of testing prior to releasing the product to market. Although testing is an important part of the software development cycle it can be a tedious process. Thus, it is not surprising that computer programmers responsible for writing the code are loath to perform testing frequently on the code as significant portions of the software program is being coded. Most software development teams comprise a quality assurance or tester sub-team whose goal is to test the software repeatedly to discover all the possible reliability issues. Relying on the testers to discover bugs in software code may not always be the most effective way of testing code because by the time testers have access to certain components of the software code the bug may have been propagated throughout the entire software program. Thus, it is desirable for programmers themselves to test components of software as they are being created to ensure that each component functions as it is supposed to before integrating the component with the rest of the program.

FIG. 1 illustrates a typical test environment whereby a test program 110 exercises a target program 120 to discover bugs. Such tests typically exercise the entire target program 120 and are referred to as acceptance tests or functional tests. Functional tests may also exercise portions or components of target programs but their focus would still be to test a broad level of functionality not necessarily any specified units of code or narrow distinct pieces of functionality. In a complex software program a broader level of functionality may be implemented using a large number of code units. For example, in the context of object-oriented programming, implementing a particular function may involve multiple classes and multiple methods associated with such classes. Depending on the context, not all classes are always used for executing a particular function. Thus, it is sometimes necessary to test a particular class or a method associated with such a class in isolation to ensure it functions as the programmer intended. Such targeted tests focused on narrow functionality or discrete units of code (e.g., a particular method or class) are typically referred to as unit tests.

Unit tests provide a technique for a programmer to test a particular code unit (e.g., class, method etc.) performing a narrow function that he or she has written without waiting to develop and use other code units that may be necessary to implement a much broader functionality. Thus, unit tests are faster to develop and a much more targeted alternative to the more expansive functional tests. FIG. 2 illustrates a typical unit test wherein a unit test program 205 exercises a specific code unit 206 within the target program 215. Similarly, a second unit test program 210 exercises a second code unit 211 within the same target program 215.

Performing unit tests have been made easier by the promulgation of several popular unit testing frameworks such as JUnit for the Java programming language, CppUnit for the C++ programming language and SUnit for Smalltalk programming language. JUnit has been used widely in testing Java based software programs. However, JUnit framework only provides for methods of testing code units running on a single virtual machine. A typical unit test may have a general structure as follows:
1. Create some objects.
2. Send those objects some messages.
3. Verify some assertions.
   The JUnit test framework, for instance, will allow a test program or test suite to exercise a target program running on a single virtual machine in the manner described above. However, there are application programs whose semantics require that their code be executed across multiple virtual machines. None of the unit testing frameworks provide for such capability. For example, Gemfire™ by GemStone® systems of Beaverton, Oreg. is a data sharing tool wherein its units of code being subjected to unit testing may in some instances be executed across multiple virtual machines. Also, such a program may require that the different steps of a typical unit test (e.g., create some objects, send those objects some messages and verify some assertions) occur in different virtual machines. None of the existing unit test frameworks including JUnit provide for methods capable of such unit testing involving multiple virtual machines. Thus, there is a need in the art for a simple unit testing framework for performing unit tests across multiple virtual machines.

### SUMMARY

Described herein are simplified methods and systems for performing unit tests on a target program being executed on a plurality of virtual machines. A virtual machine manager is described herein for configuring a test environment comprising a specified plurality of virtual machines according to a configuration file. In one aspect, the virtual machine manager manages the process of receiving a specification of the test environment for unit testing and, in response, it is capable of launching the specified number of virtual machines.

In another aspect, the virtual machine manager executes test programs specifying discrete units of code of a target program on a specified plurality of the virtual machines. The instructions of the test program are capable of specifying the exact unit of code of the target program to be run or executed on a specified one of the plurality of virtual machines. Thus, multiple such instructions may be combined to form a test program or suite capable of conducting a unit testing whereby proper functioning of the target program may have to be verified by executing portions of its code across a plurality of virtual machines.

In yet another aspect, instructions are described for generating a network comprising a plurality of virtual machine objects capable of being configured on multiple physical machines. Furthermore, instructions are described herein for specifying one or more methods or other units of code of a target program to be invoked for execution on one or more of the specified plurality of virtual machines.

In one more aspect, upon detection of a failure in execution of the selected units of code of a target program an exception object is returned to the virtual machine manager. Among other things, the exception object comprises a stack trace capable of identifying the exact one or more of the virtual machines on which the failure occurred.

Additional features and advantages of the systems and methods described herein will be made apparent from the following detailed description that proceeds with reference to the accompanying drawings.

### BRIEF DESCRIPTION OF DRAWINGS

FIG. 1. is a block diagram illustrating a typical test environment.

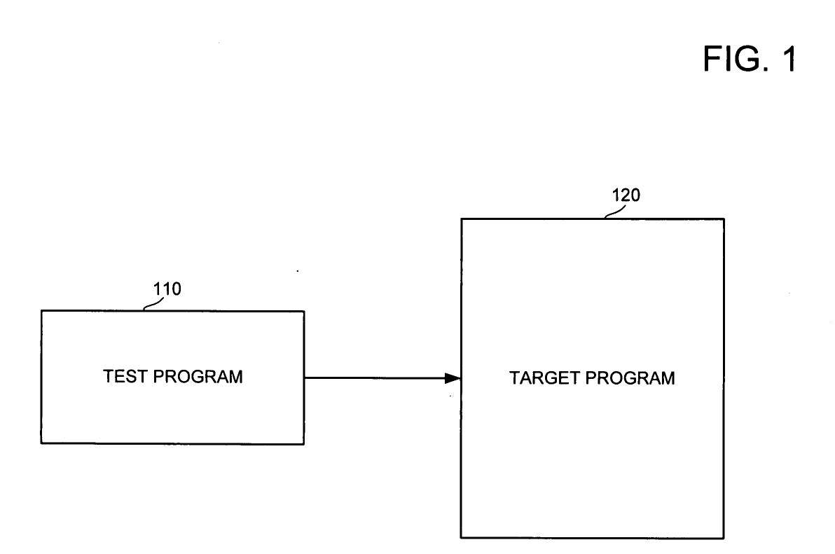

FIG. 2. is a block diagram illustrating unit testing specific units of code addressed to verifying discrete functionality of a target program.

FIG. 3. is a block diagram illustrating an exemplary method of performing unit tests by executing discrete code units of a target program across a plurality of virtual machines.

FIG. 4. is a block diagram illustrating an exemplary method of performing unit tests by executing discrete code units of a target program across a plurality of virtual machines wherein the plurality of virtual machines are configured on multiple physical machines.

FIG. 5. is a flow diagram describing an exemplary method for performing unit tests of discrete units of code of a target program on a plurality of virtual machines.

FIG. 6. is a block diagram illustrating an exemplary system for performing unit tests of discrete units of code of a target program on a plurality of virtual machines.

FIG. 7. is a listing of code for configuring a unit test to be performed on a plurality of virtual machines.

FIG. 8. is a listing of code of a unit test program to be performed on a plurality of virtual machines.

### DETAILED DESCRIPTION

### An Overall Description of Exemplary Methods for Performing Unit Testing on Multiple Virtual Machines

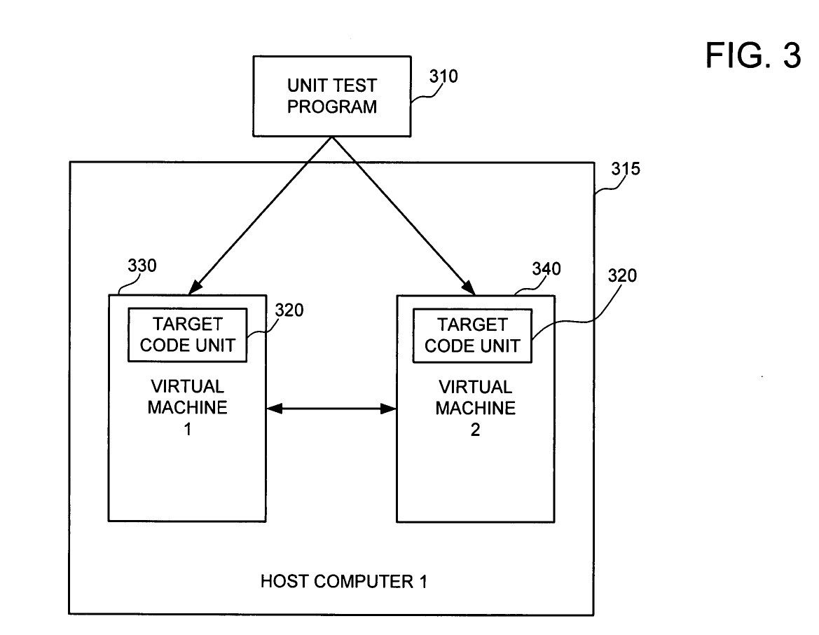

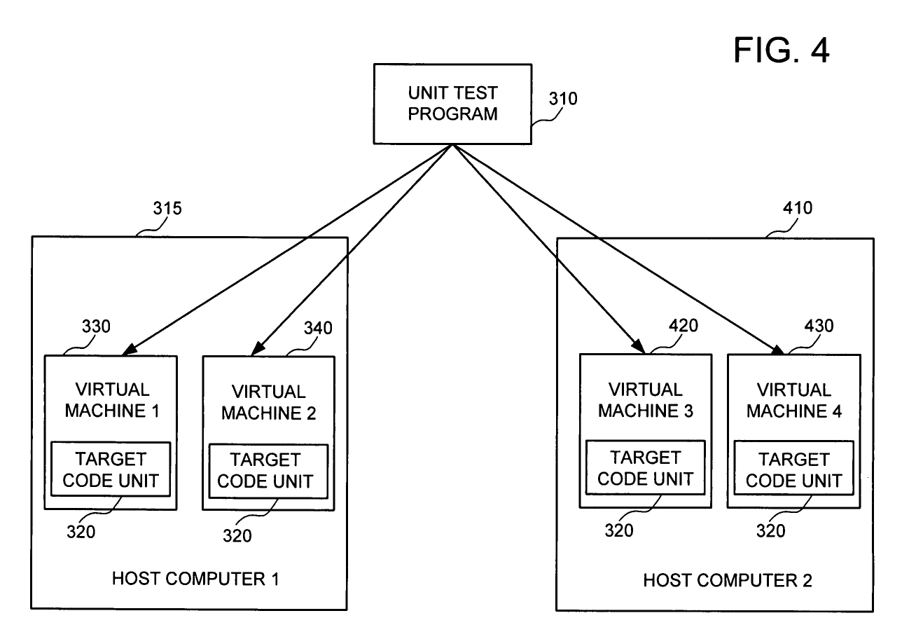

Proper and thorough testing of some target programs may require tests to be conducted with units of target program's code being executed across multiple virtual machines. FIG. 3 illustrates one example wherein a unit test program 310 conducts a test by causing the execution of target code units 320 on multiple virtual machines 330 and 340. In this example, both the virtual machines 330 and 340 happen to be on the same physical machine, host computer 1 at 315. However, it is also possible that some target programs may have code units 320 that require testing by being executed across not only multiple virtual machines 330 and 340 on a single physical machine 315 but may also include multiple virtual machines 420 and 430 on another separate physical machine 410 as shown in FIG. 4.

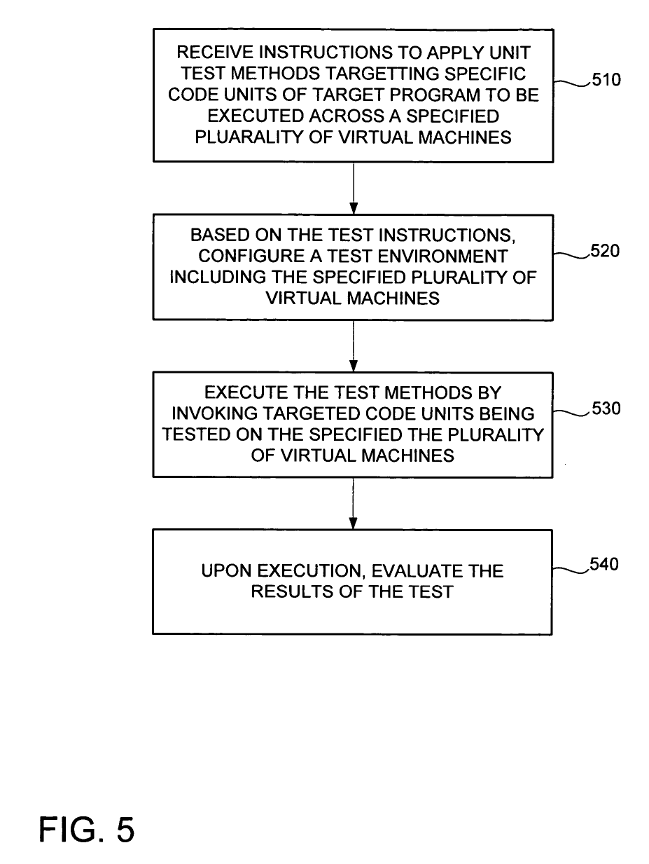

FIG. 5 illustrates an exemplary method for implementing unit testing across multiple virtual machines. At 510, instructions are received for testing selected units of code in a target program. The instructions may include a specification for configuring the test environment which may specify (among other things) the number of different virtual machines on which selected units of code are to be executed to properly complete the test. Then at 520, based on the test instructions, the specified number of virtual machines may be launched. This will create the test environment including a network of virtual machines and then at 530, the targeted units of code specified in the test instructions may be executed within one or more of the virtual machines in the test environment. Also, based on the test instructions, the selected units of target program's code may be required to run on specific virtual machines within the test environment network. This is in contrast to methods that simply require a functional test be scaled to run on a specified number of virtual machines without providing the granular level of control required to specify which of the code units being tested are run on which of the virtual machines in the network. Finally, at 540, the results of the test may be evaluated to determine failure, success or any other data indicative of the reliability of the target program.

### An Exemplary System for Implementing the Method of Performing Unit Tests on Multiple Virtual Machines

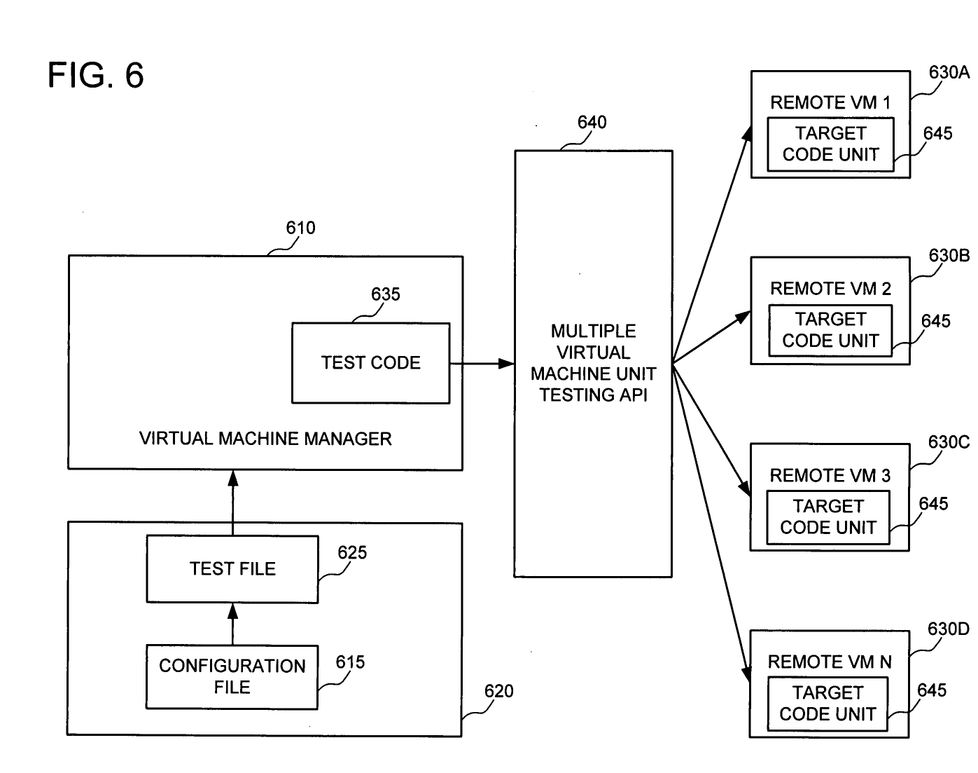

FIG. 6 illustrates an exemplary system for performing unit tests on multiple virtual machines. The system comprises a virtual machine manager 610, which receives test instructions 620 including a test configuration file 615 comprising a specification of the number of virtual machines to be launched in order to form the test environment on which to conduct unit tests. The instructions 620 may also include test program files 625 comprising test methods to invoke execution of units of code related to the target programs 645. Upon receiving instructions 620 to launch a test, the virtual machine manager 610 is responsible for reading the configuration file 615 and starting the virtual machines (e.g., 630 A-D) specified within the configuration file 615. This essentially configures the test environment in which the test will be conducted.

The test program file 625 may be provided as part of the test instructions 620 and may be loaded and executed as test code 635 on the virtual machine manager 610. The test code 635 itself may comprise method or function calls based on a multiple virtual machine unit-testing Application Programming Interface (API) 640, which may comprise several methods and functions by which the virtual machine manager 610 can remotely invoke and control the execution of units of code 645 being targeted for testing on specific remote virtual machines (e.g., 630 A-D). The virtual machine manager 610 may itself be configured as a separate virtual machine accessible to the tester. However, the remote virtual machines (e.g., 630 A-D) do not have to be launched on a physical machine separate and remote from the physical machine running the virtual machine manager 630. In fact, the virtual machines (e.g., 630 A-D and 610) shown in FIG. 6 may all be configured on the same physical machine.

### An Exemplary Programming Interface for Invoking and Otherwise Controlling the Execution of Test Methods on Multiple Virtual Machines

To control and execute the testing of a target program a tester first needs to develop a test program with instructions on performing the test. More particularly, a tester may use methods and functions of a multiple virtual machine unit-testing Application Programming Interface (API) 640 for invoking units of code (e.g., 645) belonging to the target program (e.g., 215) and controlling the execution of such units of code. The following set of classes may form a basic framework for such an exemplary programming interface 640.

TABLE 1

| Class | Description |
|---|---|
| DistributedTestCase | This class is defined as the super class of |
| | all test cases |
| Host | Objects of this class represent a host |
| | computer comprising at least one virtual |
| | machine upon which units of code related |
| | to the target program may be invoked |
| VM | Objects of this class represent a virtual |
| | machine configured on one of the host |
| | computers forming part of a virtual |
| | machine network of the test environment |
| RMIExeption | A class for exception objects thrown when |
| | errors occur during invocation of code |
| | units related to the target program being |
| | subjected to the test |

The constructor for a distributed test case class may be as follows:
Public DisributedTestCase (MyTestCase)
   The above constructor will create an exemplary new test case named MyTestCase whose functionality can be further described in code using the methods and functions available via the rest of the classes of the multiple virtual machine unit testing framework of Table 1 above. For instance, the test program may further designate one or more host computers (e.g., 315 and 410) on which to invoke one or more units of code (e.g., 645) related to target program (e.g., 215) being tested. An object of the Host class may be invoked to designate such a host computer for testing. The constructor for a Host class may be as follows:
Host (String HostName)
   The above constructor will create an object of the host class with the name of HostName. Several such host objects may be created to form a network of virtual machines to form the test environment. Within in each host object one or more virtual machines may be configured by creating objects of VM (Virtual Machine) class from Table 1. For instance, the following may be a constructor for a VM object:
VM(Host HostName, Int ProcessId)
   The constructor above creates a new virtual machine object on a given host computer. Multiple such virtual machine objects may be created to form a network of virtual machines for unit testing targeted code. Methods and functions associated with the VM objects can then be used to execute specific units of code related to the target program on specific virtual machines of the network (e.g., 630A). Any test program written using the Host and VM class objects is scaleable such that a network of virtual machines can be started that comprises any combination of host computers and virtual machines on which specified units of code may be executed for testing.

### An Exemplary Configuration File for Configuring a Network of Virtual Machines

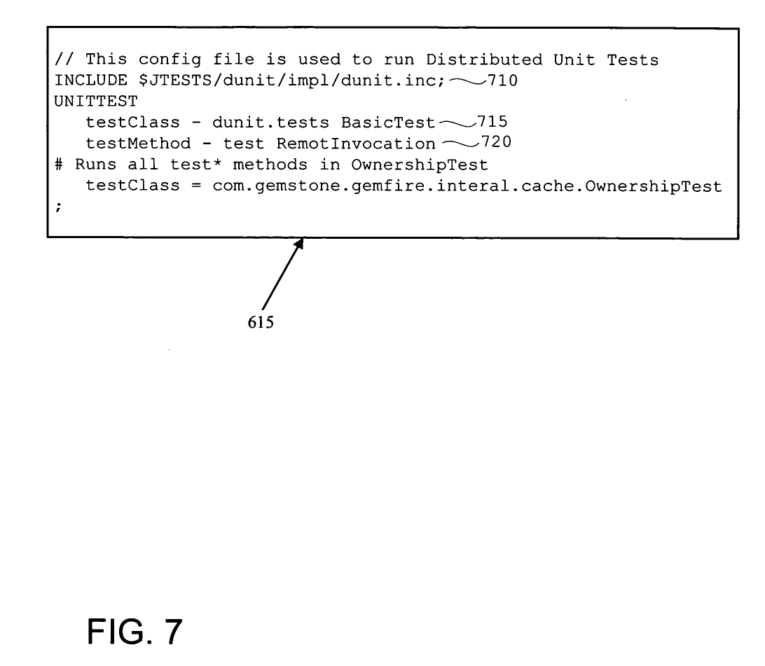

FIG. 7 is a listing of programming code related to a configuration file 615 which instructs the virtual machine manager 610 to generate the network of virtual machines which forms the multiple virtual machine network for unit testing and it may also designate the test program 625 which will be run to perform the test on the virtual machines of the configured network. The configuration of the appropriate number of hosts and the number of the virtual machines thereon including their designated names may be specified as part of a separate file (e.g., “dunit.inc”) at 710 and included within the configuration file 615. Next at 715, a multiple virtual machine unit test “BasicTest” which is a subclass of the DistributedTestCase class from Table 1 above may be invoked. In this example, this statement 715 essentially designates the test program file 625 that will be run in the test environment including the network of virtual machines as described by the dunit.inc file 710. Also, within the configuration file 615, the specific methods (e.g., 720) within the test program file 715 (625) may be specified. This is so because a particular test case of DistributedTestCase may have more than one test method described therein. Thus, the configuration file 615 configures the network of virtual machines for the test environment and also selects the test program's files 715 (625) that will be run to conduct the test. The test program file 715 (625) itself can be written and provided to the virtual machine manager 610 such that when the virtual machine manager 610 reads the configuration file 615 it has the ability to access the test program file 715 (625) and execute it accordingly. The test program itself may use the Host and VM class objects to designate which of the targeted units of code are to be executed on which of the virtual machines of the network. Alternatively, the test program may simply specify that certain targeted units of code may need to be executed on different virtual machines and different host computers, whereas the configuration file can be used to specifically designate which of the virtual machines of the network are used for execution.

### An Exemplary Test Program for Testing Units of Code within a Test Environment Comprising a Network of Multiple Virtual Machines

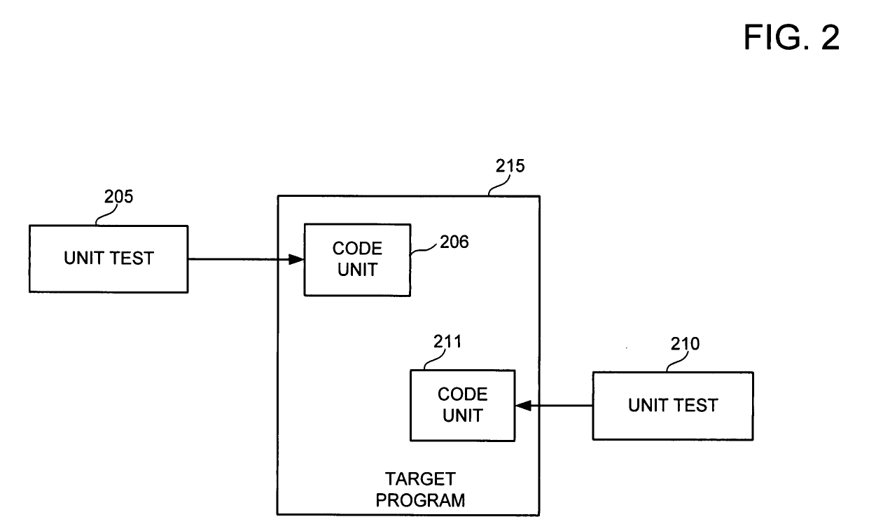

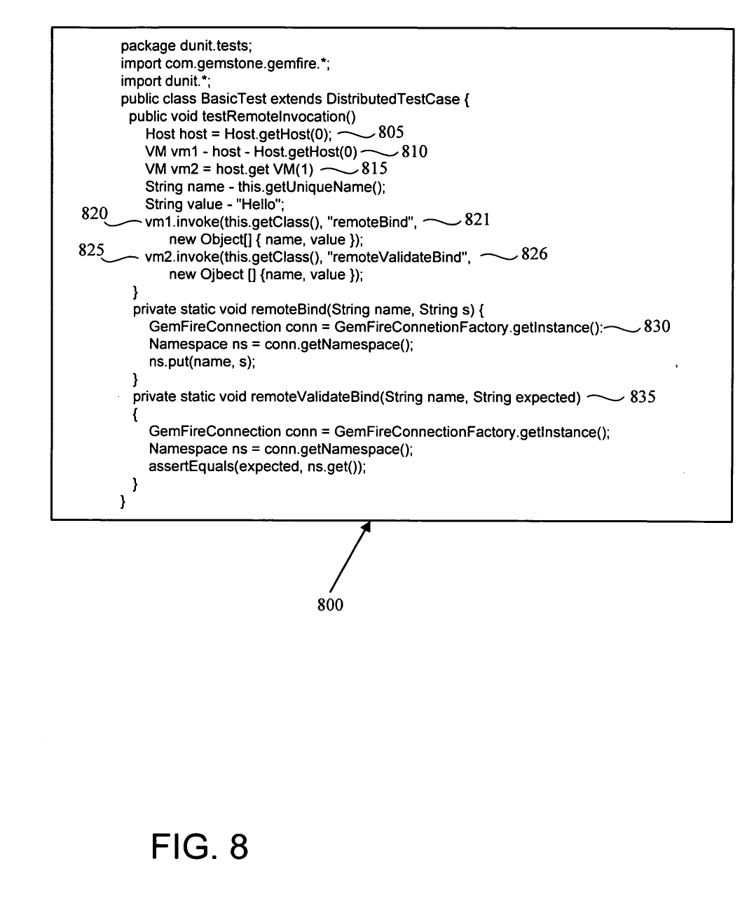

Before a test program 625 can be executed on a virtual machine manager 610 it has to be first written and made available to the virtual machine manager 610. FIG. 8 illustrates an exemplary listing 800 of a test program which uses method and function calls of the multiple virtual machine unit-testing Application Programming Interface 640 (Table 1) to invoke targeted units of code for testing such code units (e.g., 645) across multiple virtual machines (e.g., 630 A-D). The listing 800 of FIG. 8 defines the test program titled “BasicTest” which was listed in the exemplary configuration file of FIG. 7. According to the listing of FIG. 8, the testing is to be conducted on two virtual machines a VM1 at 810 and a VM2 at 815 configured on the same host computer Host 0 at 805. The test program listing 800 further comprises the Invoke method calls at 820 and 825 for invoking specific units of code (e.g., “RemoteBind” at 820 and “RemoteValidateBind” at 825) on virtual machines VM1 810 and VM2 815 respectively. The Invoke method is configured as a method of objects of virtual machine (VM) class and may be described as follows:
Invoke(Class c, String method name, Object argument)
   The Invoke method described above can essentially invoke a method specified in its method name field listed above. In this example, the method names invoked are “RemoteBind” at 820 and “RemoteValidateBind” at 825 on virtual machines VM1 810 and VM2 815 respectively. At 830 and 835, the “RemoteBind” at 820 and “RemoteValidateBind” at 825 are further defined respectively. These definitions 830 and 835 further specify the exact units of code (e.g., 645 with reference to FIG. 6) related to the target program (e.g., 215 with reference to FIG. 2) that will be executed on the multiple virtual machines (e.g., 630 A-D) as configured by the configuration file 615.

Thus in this manner, the listing 800 describes a unit test for testing the targeted units of code 830 and 835 on multiple virtual machines VM1 810 and VM2 815. Furthermore, selected units of code 830 and 835 can be designated to be tested on selected multiple virtual machines (e.g., VM1 810 and VM2 815). In this example listing of 800, the target program functionality being tested is the capability to test the sharing of a data object between two virtual machines VM1 810 and VM2 815. This operation on a first virtual machine VM1 810 designates and stores a data object in shared memory under a given name according to “RemoteBind” method at 820 and later the same data object should be available for use by a second virtual machine VM2 815. For testing purposes, this may be verified by the “RemoteValidateBind” 825 method. Thus, the semantics of this simple test program 800 itself spans multiple virtual machines (VM1 810 and VM2 815) and a unit test for testing data object sharing between multiple virtual machines cannot be verified or appropriately tested without the relevant units of code subjected to testing being run on multiple virtual machines. Such testing was not possible by existing unit testing frameworks (e.g., JUnit). However, such testing is made possible by first configuring a multiple virtual machine test environment according to a configuration file 615 and using the Invoke method of the VM (Virtual Machine) class and the rest of the API framework 640 (Table 1 above).

Alternatively, the Invoke method may be further varied from the example described, for instance, by adding or removing arguments. In one embodiment, a Invoke method may be used to invoke targeted code units to execute asynchronously from its caller. This may mean for instance that multithreading operating systems can be used to concurrently (as opposed to in a serial manner) invoke target code units.

### Exemplary Methods for Exception Handling when Performing Unit Testing on a Multiple Virtual Machine Network

In the event of detecting a failure during unit testing, it is essential that the code unit (e.g., 645) and the virtual machine (e.g., 630 A-D) executing the code unit (e.g., 645) when the failure occurred be propagated back to the original caller. For instance, if the virtual machine manager 610 is executing the test code 635 and encounters a failure, remote method invocation frameworks such as Common Object Request Broker Architecture (CORBA) and Remote Method Invocation (RMI) can only provide a stack trace that traces the exception to the virtual machine executing the virtual manager 610 not the remote virtual machine (e.g., 630 A-D) executing the faulty code. However, when an exception occurs during a remote method invocation an object of RMIException class (Table 1) may be thrown which provides for a stack trace that appropriately identifies one of the remote virtual machines (e.g., 630 A-D) as the source of the exception not the virtual machine running the virtual machine manager 610. This allows for proper resolution of the errors in a network of remote virtual machines.

### Alternatives

Having described and illustrated the principles of our invention with reference to the described embodiments, it will be recognized that the described embodiments can be modified in arrangement and detail without departing from such principles. For instance many of the examples list instructions in Java programming language. However, the methods and systems of the invention may be implemented in any programming language.

Also, it should be understood that the programs, processes, or methods described herein are not related or limited to any particular type of computer apparatus. Various types of general purpose or specialized computer apparatus may be used with or perform operations in accordance with the teachings described herein. Actions described herein can be achieved by computer-readable media comprising computer-executable instructions for performing such actions. Elements of the illustrated embodiment shown in software may be implemented in hardware and vice versa. In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. In a system comprising a virtual machine manager process for managing operation of virtual machines, a method of performing unit tests on a specified plurality of the virtual machines, the method comprising:
receiving instructions to configure a network of virtual machines comprising the specified plurality of virtual machines;
based on the instructions to configure the network of virtual machines, configuring the network by launching the specified plurality of virtual machines;
executing a test program to invoke execution of selected units of code of a target program on the specified plurality of the virtual machines; and
verifying that actual results of the execution of selected units of code matches expected results.

2. The method of claim 1 wherein the network of virtual machines is configured by creating at least one host computer object and a plurality of virtual machine objects associated with the at least one host computer object.

3. The method of claim 1 wherein the virtual machine manager invokes the execution of selected units of code of the target program by issuing remote invocation method calls addressed to the specified plurality of virtual machines and specifying at least one unit of code of the targeted program to be executed by the specified plurality of virtual machines.

4. The method of claim 1 wherein the specified plurality of virtual machines are configured on a plurality of host computers.

5. The method of claim 1 wherein the invocation of execution of selected units of code of the target program is asynchronous.

6. The method of claim 1 further comprising, receiving an exception object indicative of an error in execution of at least one of the selected units of code of the targeted program.

7. The method of claim 6 wherein the exception object further specifies at least one of the specified plurality of virtual machines on which the error in execution occurred.

8. A system for performing unit tests of selected units of code on a specified plurality of the virtual machines, the system comprising:
a virtual machine manager for configuring a network of virtual machines comprising the specified plurality of virtual machines for conducting unit tests of selected units of code of target programs; and
a test program file to be executed by the virtual machine manager and comprising instructions for invoking execution of the selected units of code of the target program on the specified plurality of the virtual machines.

9. The system of claim 8 wherein the instructions for invoking execution of the selected units of code of the target program on the specified plurality of the virtual machines comprises remote invocation calls to the specified plurality of virtual machines.

10. The system of claim 8 wherein the specified plurality of virtual machines are configured on a plurality of host computers.

11. The system of claim 8 wherein the virtual manager is further operative for receiving an exception object indicative of an error in execution of at least one of the selected units of code of the targeted program and determining at least one of the specified plurality of virtual machines on which the exception causing error occurred.

12. The system of claim 8 wherein the virtual machine manager is further operative for responding to instructions specifying invocation of execution of the selected units of code of the target program in a asynchronous manner.

13. At least one computer readable medium having stored thereon computer-executable instructions related to performing unit tests of selected units of code of a target program on a specified plurality of virtual machines, the instruction comprising:
input parameters representing units of code selected for execution on the specified plurality of virtual machines; and
executable software for receiving the input parameters, executing the units of code selected for execution on the specified plurality of virtual machines and in response to a failed execution of at least one of the selected units of code, generating exception objects indicative of at least one of the specified plurality of virtual machines on which the failure occurred.

14. The computer readable medium of claim 13, wherein the units of code selected for execution on the specified plurality of virtual machines are represented in the input parameters as methods of a virtual machine object.

15. The computer readable medium of claim 13 wherein the exception object comprises a stack trace indicative of the at least one of the specified plurality of virtual machines on which the failure occurred.
